(19) United States
(12) Patent Application Publication
(10) Pub. No.: US 2018/0253995 A1
(43) Pub. Date: Sep. 6, 2018

(54) Seed Pack, Plant Seed and Seed Marker System, Apparatus and Method

(71) Applicant: Daniel L. Amend, Saugerties, NY (US)

(72) Inventor: Daniel L. Amend, Saugerties, NY (US)

(21) Appl. No.: 15/972,558

(22) Filed: May 7, 2018

(51) Int. Cl. G09F 3/02; H04N 1/00; H04N 1/23; A01C 21/00; B65D 77/28

(52) U.S. Cl. CPC G09F 3/02; H04N 1/0066; G09F 2003/0208; A01C 21/00; B65D 77/28; H04N 1/2323

(57) ABSTRACT

A seed pack, plant seed and marker system and related apparatus and method, comprising: a seed pack; a plurality of plant seeds contained within the seed pack; identifying information pertaining to the plant seeds printed on an outside surface of the seed pack; growing guidelines pertaining to the plant seeds printed on the outside surface of the seed pack; a plurality of preprinted seed markers integrally packaged together with the seed pack and the seeds; at least some of the identifying information pertaining to the seeds also preprinted on the preprinted seed markers; and at least some of the growing guidelines pertaining to the seeds also preprinted on the preprinted seed markers.

### BACKGROUND OF THE INVENTION

Gardening to raise and possibly thereafter harvest all types of edible and inedible plants, is a very popular hobby worldwide. Although plants are often sold to consumers while those plants are young sprouts, it is also common practice to sell seed packs to gardening enthusiasts, so that these gardeners can grow a set of plants right from the seed stage.

Of course, during the first number of days when a seed 3 (schematically illustrated by a plurality of plant seeds 3 in FIG. 3) has not yet broken the starter soil surface, especially if multiple types of plants are being grown, it is impossible for the gardener to know which types of plants are growing in which sections of starter soil absent some system for marking the plant types.

In the prior art, as illustrated in FIG. 1, the gardening consumer/user will often purchase a number of blank or substantially blank seed markers 1 with a soil-penetrating tip 11, which markers 1 can be placed with their tips 11 in the soil near any given seed or group of seeds 3. The user then employs a (preferably-indelible) writing device to write onto the marker 1, information regarding what type of seeds 3 it will be used to mark. Then, after the seeds 3 have been planted, the user thrusts the tip 11 into the soil near those seeds 3, and the marker 1 thereafter reminds the user what seeds 3 are growing proximate thereto.

Of course, different plants are suitable for growth in different climates, and with varying sun exposure, and moisture and food requirements, and so need to be tended to in different ways. Therefore, there are invariably growing guidelines associated with each type of plant. Besides the particular variety of plant, these guidelines will often include such variables recommended degree of sun or shade exposure, appropriate USDA growing zone, hot and cold extremes, best times to plant, recommended seed separation, preferred food types, and watering requirements. So as shown in FIG. 2, it is not uncommon for a seed pack 2 which contains the seeds 3 being sold/purchased to also comprise identifying information 21, 24 (in this case, as an illustrative nonlimiting example, the words “Gardeners' Choice Tomato,” and an illustration of the tomatoes themselves), as well as growing guidelines 22 pertaining to the related seeds 3 (in this case, as an illustrative nonlimiting example, guidelines for starting the seeds indoors and setting the plants outdoors). Also illustrated on the seed pack 2 is a seed pack closure flap 23.

Because it is desirable for the user to know and have easy access to this information not only when planting seeds 3, but thereafter throughout the entire growing season, the user must either retain the seed pack 2 or other accompanying literature, if any, as a reference guide after all the seeds 3 have been planted. Or the user must photocopy the information and keep it somewhere accessible. Or, the user needs to copy the most pertinent information by hand onto the markers 1 which he or she has separately purchased. This is all rather cumbersome, and if the seed pack 2 or its copy should become lost, the user must then go to extraordinary measures to retrieve that same information.

It would be desirable to have a means of having all pertinent plant and growing information available directly on markers 1 sold as part and parcel of the seed pack 2 containing the seeds 3 and, so that this information can be easily maintained with the seeds 3 and with the plants into which they grow.

### SUMMARY OF THE INVENTION

Disclosed herein is a seed pack, plant seed and marker system and related apparatus and method, comprising: a seed pack; a plurality of plant seeds contained within the seed pack; identifying information pertaining to the plant seeds printed on an outside surface of the seed pack; growing guidelines pertaining to the plant seeds printed on the outside surface of the seed pack; a plurality of preprinted seed markers integrally packaged together with the seed pack and the seeds; at least some of the identifying information pertaining to the seeds also preprinted on the preprinted seed markers; and at least some of the growing guidelines pertaining to the seeds also preprinted on the preprinted seed markers.

### BRIEF DESCRIPTION OF THE DRAWINGS

The features of the invention believed to be novel are set forth in the appended claims. The invention, however, together with further objects and advantages thereof, may best be understood by reference to the following description taken in conjunction with the accompanying drawing(s) summarized below.

FIG. 1 illustrates a blank seed marker with a soil-penetrating tip, in a form often made available to gardeners in the prior art.

FIG. 2 contains an illustrative example of a seed pack in accordance with what is often provided to gardeners in the prior art.

FIG. 3 illustrates a collection of seeds often provided to gardeners in a seed pack, in the prior art.

FIG. 4 illustrates, for example not limitation, a plurality of four (4) preprinted seed markers provided on a single scored sheet, used in accordance with a first preferred embodiment of the invention.

FIG. 5 illustrates the first preferred embodiment of the invention in which one or more of the preprinted seed marker sheets of FIG. 4 is provided along with the associated seeds inside a seed pack. This figure also illustrates the removal by the user, of the seed markers from the seed pack.

FIG. 6 illustrates, for example not limitation, a plurality of four (4) separate preprinted seed markers, used in accordance with a second preferred embodiment of the invention.

FIG. 7 illustrates the second preferred embodiment of the invention in which one or more of the separated preprinted seed markers of FIG. 6 is provided along with the associated seeds inside a seed pack.

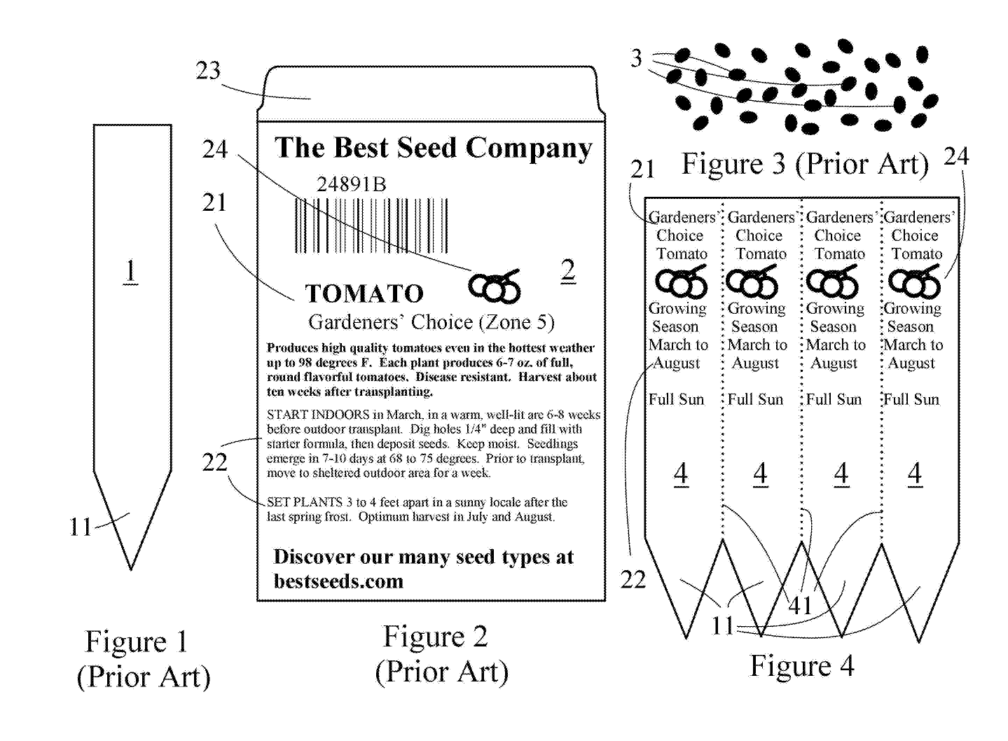

### DETAILED DESCRIPTION

Turning now to the specifics of the invention, FIG. 4 illustrates, for example not limitation, a plurality of four (4) preprinted seed markers 4 used in accordance with the invention. Each preprinted marker 4 contains identifying information 21, 24 related to the seeds 3, corresponding to the identifying information 21, 24 printed on the seed pack 2. It is not necessary for all of the identifying information 21, 24 on the seed pack 2 to be replicated on the seed markers 4; it suffices in accordance with the invention for at least a subset of this information to be printed on the seed markers 4.

Each preprinted marker 4 additionally contains growing guidelines 22 pertaining to the related seeds (in this case, as an illustrative nonlimiting example, “Growing Season March to August” and “Full Sun.”) which is a subset of the guidelines 22 printed on the seed pack 2. As illustrated, each seed pack 2 and/or preprinted marker 4 may also contain an optional drawing or photographic rendition 24 of the plants into which the seeds 3 will eventually grow, as part of the identifying information 21, 24.

Additionally, in a first preferred embodiment of the invention, the plurality of preprinted seed markers 4 are attached to one another on a single preprinted marker sheet as illustrated in FIG. 4, and are also separable from one another using pre-fabricated breakable score lines 41. The soil-penetrating tip 11 of each marker 4 is fabricated with each marker. It will be apparent to persons of ordinary skill in the printing and cutting arts how to fabricate, cut, pre-score, and print such sheets, using suitable materials comprising plastics, woods, composites, etc., for example, not limitation.

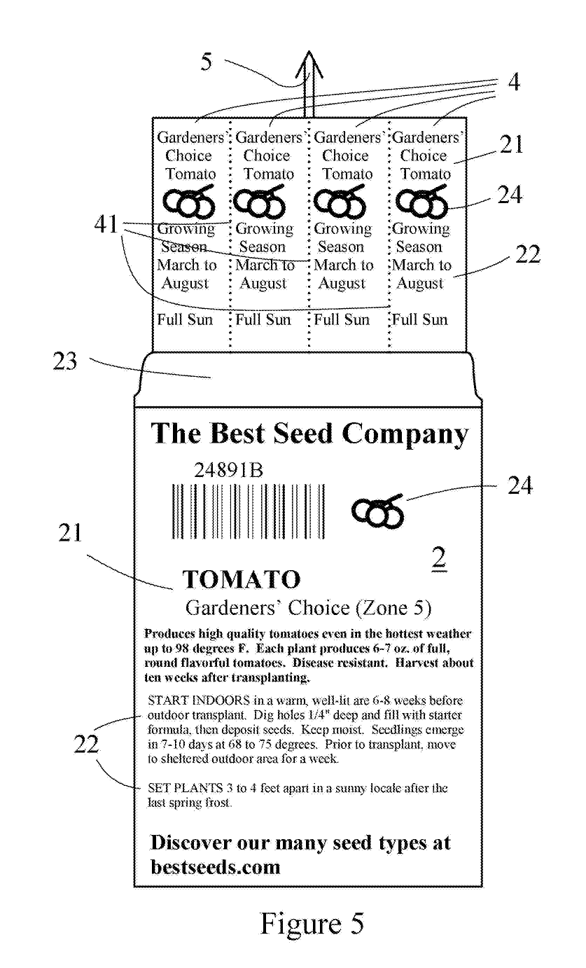

In this first embodiment of the invention, as illustrated in FIG. 5, one or more pre-scored 41, preprinted marker sheets comprising a plurality of preprinted seed markers 4 are contained along with the associated seeds 3 inside the seed pack 2. After the consumer purchases the seed pack, when the user lifts a flap 23 to start extracting the seeds, the user also slides the seed markers 4 out of the seed pack as illustrated by the arrow 5, and so also has those markers 4 imminently available to mark the seeds 3 which are also inside the same pack 2. Then the user removes the seeds 3, plants the seeds 3, and after breaking apart and separating one or more of the seed markers 4 from one another along the score lines 41, presses the tips 11 of the preprinted seed markers 4 to anchor them into the soil proximate the associated planted seeds 3. Once anchored, these preprinted seed markers 4 serve to identify in text 21 and visually 24 what seeds they are proximate, and also, to provide suitable guidance 22 as to the key growing variables for those seeds. These preprinted seed markers 4 may optionally be kept in place after the seedlings have broken ground. And once the plants are set into their final locations, these preprinted seed markers 4 may also be optionally re-situated to accompany the plants, continuing to serve as an identifier 21, 24 and as a guide 22.

While it is preferred that at the point of sale preprinted seed markers 4 be contained along with the associated seeds 3 inside the seed pack 2 so the markers 4 may be later removed by the user as schematically illustrated by the arrow 5, this is for example, not limitation. These preprinted seed markers 4 may also be sold outside the seed pack 2, but in a transparent or semi-transparent wrapping package (e.g., shirk wrap) that contains both the seed pack 2 containing seeds 3, and preprinted seed markers 4. Or, other attachments known in the art may be employed to ensure that all of the preprinted seed markers 4 and the seed pack 2 and the seeds 3 be integrally packaged together in such a manner that they are not separated from the other until after purchase by the user.

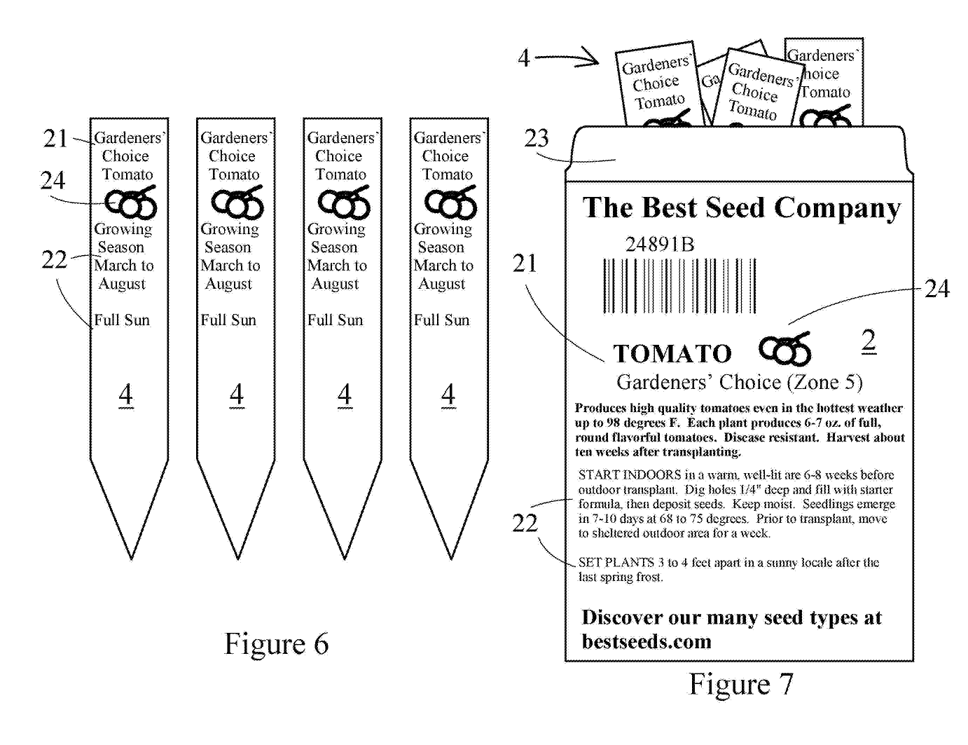

In a second preferred embodiment of the invention, the seed markers 4 are not provided to the user in the scored 41 sheets illustrated by FIG. 4, but rather are already pre-separated from one another as illustrated by FIG. 6. Then, these separated seed markers 4 are preferably contained along with the associated seeds 3 inside the seed pack 2 as illustrated by FIG. 7. But as with the first preferred embodiment, they may also be packaged together with the seed pack 2 and the seeds 3 such that these are not separated from the other until after purchase by the user, using packaging methodologies within the scope of ordinary skill in the packaging arts.

In sum, this invention in the first preferred embodiment provides a plurality of pre-printed plant markers 4 formed on one piece of material, attached and scored 41 in such a way as to allow easy individual separation by hand, as needed. In the second preferred embodiment, the pre-printed plant markers 4 are already separated at the point of sale. These are produced specifically to be placed into or physically packaged with seed packs 2 during the manufacturing process and thereby become immediately accessible to the customer upon opening the seed pack 2 for planting the seeds 3.

This invention is very useful and provides benefit for the home gardener. It is simple, convenient and useful. The materials used for the markers 4 may comprise plastic, wood, composites, etc., with any colors that may be desirable. The markers 4 should be rigid enough to hold form and penetrate the soil without breaking. They should be balanced and oriented in such a way as to not protrude through the seed pack, which is one benefit of the scored 41 sheet configuration of FIG. 4. Additionally, sheets of markers 4 will cause the seed pack 2 to retain form until these sheets are removed, thereby adding structural rigidity to the seed pack 2.

The markers should be sized to fit inside existing seed packs without altering the dimensions of the packs 2. For example, not limitation, common sizes for seed packs are 4½″×3¼″. So, for such packs, the sheets of markers 4 would, for example, be 4¼″×3″—that is, about ¼″ smaller than the linear dimensions of the seed pack 2 itself. These sizing considerations hold in general, but the specifics stated above are exemplary, not limiting. The sheets of marker 4 are also fabricated, preferably but without limitation, from flat stock which is 0.02″ to 0.0625″ thick.

These markers 4 may also be pre-printed with information as determined by the company or companies making and selling the invention, including but not limited to company name and/or logo, plant identification 21, picture 24, growing season and other growing guidelines 22. While four (4) markers have been used to illustrate the invention, this is for example not limitation. Generally given the dimensions of seed packs 2 employed in the art, it is expected that there would be 3 to 5 pre-printed plant markers per pack, to be determined by the company or companies making and selling the invention.

The knowledge possessed by someone of ordinary skill in the art at the time of this disclosure, including but not limited to the prior art disclosed with this application, is understood to be part and parcel of this disclosure and is implicitly incorporated by reference herein, even if in the interest of economy express statements about the specific knowledge understood to be possessed by someone of ordinary skill are omitted from this disclosure. While reference may be made in this disclosure to the invention comprising a combination of a plurality of elements, it is also understood that this invention is regarded to comprise combinations which omit or exclude one or more of such elements, even if this omission or exclusion of an element or elements is not expressly stated herein, unless it is expressly stated herein that an element is essential to applicant's combination and cannot be omitted. It is further understood that the related prior art may include elements from which this invention may be distinguished by negative claim limitations, even without any express statement of such negative limitations herein. It is to be understood, between the positive statements of applicant's invention expressly stated herein, and the prior art and knowledge of the prior art by those of ordinary skill which is incorporated herein even if not expressly reproduced here for reasons of economy, that any and all such negative claim limitations supported by the prior art are also considered to be within the scope of this disclosure and its associated claims, even absent any express statement herein about any particular negative claim limitations.

Finally, while only certain preferred features of the invention have been illustrated and described, many modifications, changes and substitutions will occur to those skilled in the art. It is, therefore, to be understood that the appended claims are intended to cover all such modifications and changes as fall within the true spirit of the invention.

I claim:

1. A seed pack, plant seed and marker system comprising:
a seed pack;
a plurality of plant seeds contained within said seed pack;
identifying information pertaining to said plant seeds printed on an outside surface of said seed pack;
growing guidelines pertaining to said plant seeds printed on said outside surface of said seed pack;
a plurality of preprinted seed markers integrally packaged together with said seed pack and said seeds;
at least some of said identifying information pertaining to said seeds also preprinted on said preprinted seed markers; and
at least some of said growing guidelines pertaining to said seeds also preprinted on said preprinted seed markers.

2. The system of claim 1, each said seed marker further comprising a soil-penetrating tip thereof.

3. The system of claim 1, further comprising:
at least one preprinted seed marker sheet comprising at least some of said plurality of said preprinted sheet markers;
said at least one preprinted seed marker sheet further comprising a plurality of breakable score lines for breaking apart and separating said seed markers from one another; and
said at least one preprinted seed marker sheet integrally packaged together with said seed pack and said seeds.

4. The system of claim 1, wherein said plurality of preprinted seed markers are pre-separated from one another.

5. The system of claim 1, said integral packaging of said seed markers together with said seed pack and said seeds comprising said seed markers being contained inside said seed pack.

6. The system of claim 1, said integral packaging of said seed markers together with said seed pack and said seeds comprising said seed markers being attached to an outside of said seed pack.

7. The system of claim 1, said integral packaging of said seed markers together with said seed pack and said seeds comprising said seed markers being wrapped together with said seed pack.

8. The system of claim 3, said integral packaging of said seed markers together with said seed pack and said seeds comprising said seed markers being contained inside said seed pack.

9. The system of claim 8, said seed marker sheets comprising a material which increases the rigidity of said seed pack when said seed marker sheets are contained inside said seed pack.

10. A method for assisting a gardener to identify planted seeds and to adhere to plant growing guidelines, comprising:
integrally packaging a plurality of preprinted seed markers together with a seed pack and a plurality of plant seeds contained within said seed pack;
printing identifying information and growing guidelines pertaining to said plant seeds on an outside surface of said seed pack;
preprinting at least some of said identifying information and at least some of said growing guidelines pertaining to said seeds also on said preprinted seed markers; and
providing said seed pack with said seeds and said seed markers to the gardener.

11. The method of claim 10, further comprising the gardener removing said seeds from said seed pack, removing said seed markers from said integral packaging, planting said seeds, and anchoring said seed markers into soil proximate the associated said planted seeds.

12. The method of claim 10, each said seed marker further comprising a soil-penetrating tip thereof.

13. The method of claim 10, further comprising:
at least one preprinted seed marker sheet comprising at least some of said plurality of said preprinted sheet markers;
said at least one preprinted seed marker sheet further comprising a plurality of breakable score lines for breaking apart and separating said seed markers from one another; and
said at least one preprinted seed marker sheet integrally packaged together with said seed pack and said seeds.

14. The method of claim 13, further comprising the gardener removing said seeds from said seed pack, removing said seed markers from said integral packaging, breaking apart and separating one or more of said seed markers from one another along said score lines, planting said seeds, and anchoring said seed markers into soil proximate the associated said planted seeds

15. The method of claim 10, wherein said plurality of preprinted seed markers are pre-separated from one another.

16. The method of claim 10, said integrally packaging said seed markers together with said seed pack and said seeds comprising containing said seed markers being inside said seed pack.

17. The method of claim 10, said integrally packaging said seed markers together with said seed pack and said seeds comprising attaching said seed markers to an outside of said seed pack.

18. The method of claim 10, said integrally packaging said seed markers together with said seed pack and said seeds comprising wrapping said seed markers together with said seed pack.

19. The method of claim 13, said integrally packaging said seed markers together with said seed pack and said seeds comprising containing said seed markers inside said seed pack.

20. The method of claim 19, said seed marker sheets comprising a material for increasing the rigidity of said seed pack when said seed marker sheets are contained inside said seed pack.
